(19) United States
(12) Patent Application Publication
(10) Pub. No.: US 2020/0210731 A1
(43) Pub. Date: Jul. 2, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Hiroshi Yamanaka, Wako-shi (JP); Yasushi Shoda, Wako-shi (JP); Junpei Noguchi, Wako-shi (JP); Yuki Hara, Wako-shi (JP); Yoshitaka Mimura, Wako-shi (JP); Ryoma Taguchi, Tokyo (JP); Yuta Takada, Tokyo (JP); Chie Sugihara, Tokyo (JP); Yuki Motegi, Tokyo (JP); Tsubasa Shibauchi, Tokyo (JP)

(21) Appl. No.: 16/718,262

(22) Filed: Dec. 18, 2019

(30) Foreign Application Priority Data
Dec. 28, 2018 (JP) 2018-247435

(51) Int. Cl. G06K 9/00; G05D 1/02; B60W 20/13

(52) U.S. Cl. CPC G06K 9/00832; G05D 1/021; G08G 1/142; G06K 9/00771; B60W 20/13

(57) ABSTRACT

A vehicle control system of an embodiment includes a recognizer configured to recognize a surrounding environment of a vehicle, a driving controller configured to perform driving control of speed control and steering control of the vehicle without depending on an operation of an occupant on the basis of a result of the recognition performed by the recognizer, a communicator configured to communicate with a terminal device of the occupant, and an acquirer configured to acquire a communication state between the communicator and the terminal device, in which the driving controller causes a vehicle to leave from a first parking area when the vehicle is parked in the first parking area in which the vehicle parks according to traveling based on the driving control and the communication state with the terminal device acquired by the acquirer is worse than a reference.

### CROSS-REFERENCE TO RELATED APPLICATION

Priority is claimed on Japanese Patent Application No. 2018-247435, filed Dec. 28, 2018, the content of which is incorporated herein by reference.

### BACKGROUND

### Field of the Invention

The present invention relates to a vehicle control system, a vehicle control method, and a storage medium.

### Description of Related Art

In recent years, research has advanced on automatic control of vehicles. With regard to this, a technology for limiting specific operations on a vehicle according to whether a remaining battery level of a portable unit that performs an operation on the vehicle using wireless communication is equal to or greater than a reference value is known (for example, Japanese Unexamined Patent Application, First Publication No. 2006-225975).

### SUMMARY

However, in the conventional technology, when a communication state between a terminal device and a vehicle is poor, an operation from the terminal device may not be performed and appropriate vehicle control may not be executed in some cases.

Aspects of the present invention have been made in view of such circumstances, and an object thereof is to provide a vehicle control system, a vehicle control method, and a storage medium which can perform appropriate vehicle control on the basis of a state of communication with a terminal device.

A vehicle control system, a vehicle control method, and a storage medium according to the present invention have adopted the following configuration.

(1): A vehicle control system according to one aspect of the present invention is a vehicle control system which includes a recognizer configured to recognize a surrounding environment of a vehicle, a driving controller configured to perform driving control of speed control and steering control of the vehicle without depending on an operation of an occupant on the basis of a result of the recognition performed by the recognizer, a communicator configured to communicate with a terminal device of the occupant, and an acquirer configured to acquire a communication state between the communicator and the terminal device, in which the driving controller causes a vehicle to leave from a first parking area when the vehicle is parked in the first parking area in which the vehicle parks according to traveling based on the driving control and the communication state with the terminal device acquired by the acquirer is worse than a reference.

(2): In the aspect of (1) described above, the driving controller causes the vehicle which has left from the first parking area to patrol a patrol route passing through a stop area in which the occupant is boarded.

(3): In the aspect of (1) described above, when a second parking area which allows traveling based on the driving control and traveling based on manual driving of an occupant of the vehicle is present within a movable range from the first parking area, the driving controller causes the vehicle which has left from the first parking area to park in the second parking area.

(4): In the aspect of (1) described above, the driving controller does not execute leaving of the vehicle from the first parking area when it is estimated that the communication state with the terminal device is worse than the reference due to power of the terminal device being intentionally turned off by the occupant of the vehicle.

(5): In the aspect of (1) described above, the driving controller determines whether to cause the vehicle to leave from the first parking area when the communication state with the terminal device acquired by the acquirer is worse than the reference on the basis of facility information associated with the first parking area recognized by the recognizer.

(6): In the aspect of (1) described above, the driving controller does not execute the leaving from the first parking area when the terminal device is present in a facility associated with the first parking area, and executes the leaving from the first parking area when the terminal device is present outside the facility.

(7): In the aspect of (6) described above, the communicator communicates with a plurality of the terminal devices registered in advance, and the driving controller does not execute the leaving of the vehicle from the first parking area when at least one terminal device whose communication state with the communicator is better than the reference is present within the facility among the plurality of terminal devices, and executes the leaving from the first parking area when the at least one terminal device is present outside the facility.

(8): In the aspect of (1) described above, the vehicle control system further includes a notification controller configured to perform notification on an administrator of the first parking area when the vehicle is parked in the first parking area and the communication state with the terminal device is worse than the reference.

(9): In the aspect of (1) described above, when a reservation time for arrival at which an occupant is boarded on the vehicle is set, the driving controller causes the vehicle to leave from the first parking area and to move to a boarding area of the occupant on the basis of the reservation time for arrival.

(10): In the aspect of (9) described above, the driving controller causes the vehicle to leave from the first parking area before the reservation time for arrival is reached, and causes the vehicle to park in the first parking area when the occupant is not boarded even after a predetermined time has elapsed from the reservation time for arrival.

(11): A vehicle control method according to another aspect of the present invention is a vehicle control method which includes, by a computer, recognizing a surrounding environment of a vehicle, performing driving control of speed control and steering control of the vehicle without depending on an operation of an occupant on the basis of a recognized result, communicating with a terminal device of the occupant, acquiring a communication state with the terminal device, and causing a vehicle to leave from a first parking area when the vehicle is parked in the first parking area in which the vehicle parks according to traveling based on the driving control and the acquired communication state with the terminal device is worse than a reference.

(12): A storage medium according to still another aspect of the present invention is a computer-readable non-transitory storage medium which has stored a program that causes a computer to recognize a surrounding environment of a vehicle, perform driving control of speed control and steering control of the vehicle without depending on an operation of an occupant on the basis of a recognized result, communicate with a terminal device of the occupant, acquire a communication state with the terminal device, and cause a vehicle to leave from a first parking area when the vehicle is parked in the first parking area in which the vehicle parks according to traveling based on the driving control and the acquired communication state with the terminal device is worse than a reference.

According to (1) to (12) described above, it is possible to appropriately perform vehicle control on the basis of a communication state with a terminal device.

### BRIEF DESCRIPTION OF THE DRAWINGS

FIG. 1 is a configuration diagram of a vehicle system using a vehicle control system according to an embodiment.

FIG. 2 is a functional configuration diagram of a first controller and a second controller.

FIG. 3 is a diagram which shows an example of a functional configuration of a terminal device.

FIG. 4 is a diagram which schematically shows a scene in which a self-propelled parking event in the embodiment is executed.

FIG. 5 is a diagram which shows an example of a configuration of a parking lot management device.

FIG. 6 is a flowchart which shows a flow of processing executed by an automated driving control device in first and second control patterns.

FIG. 7 is a flowchart which shows a flow of processing executed by an automated driving control device in a third control pattern.

FIG. 8 is a flowchart which shows a flow of processing executed by an automated driving control device in a fourth control pattern.

FIG. 9 is a flowchart which shows a flow of processing executed by an automated driving control device in a fifth control pattern.

FIG. 10 is a flowchart which shows a flow of processing executed by an automated driving control device in a sixth control pattern.

FIG. 11 is a flowchart which shows a flow of processing executed by an automated driving control device in a seventh control pattern.

FIG. 12 is a diagram which shows an example of a hardware configuration of the automated driving control device of the embodiment.

### DESCRIPTION OF EMBODIMENTS

Hereinafter, embodiments of a vehicle control system, a vehicle control method, and a storage medium of the present invention will be described with reference to the drawings. In the following description, as an example, an embodiment in which the vehicle control system is applied to an automated driving vehicle will be described. Automated driving, for example, executes driving control by controlling one or both of steering and acceleration or deceleration of a vehicle regardless of an operation of an occupant. The automated driving vehicle may have driving control executed by a manual operation of the occupant.

[Overall Configuration]

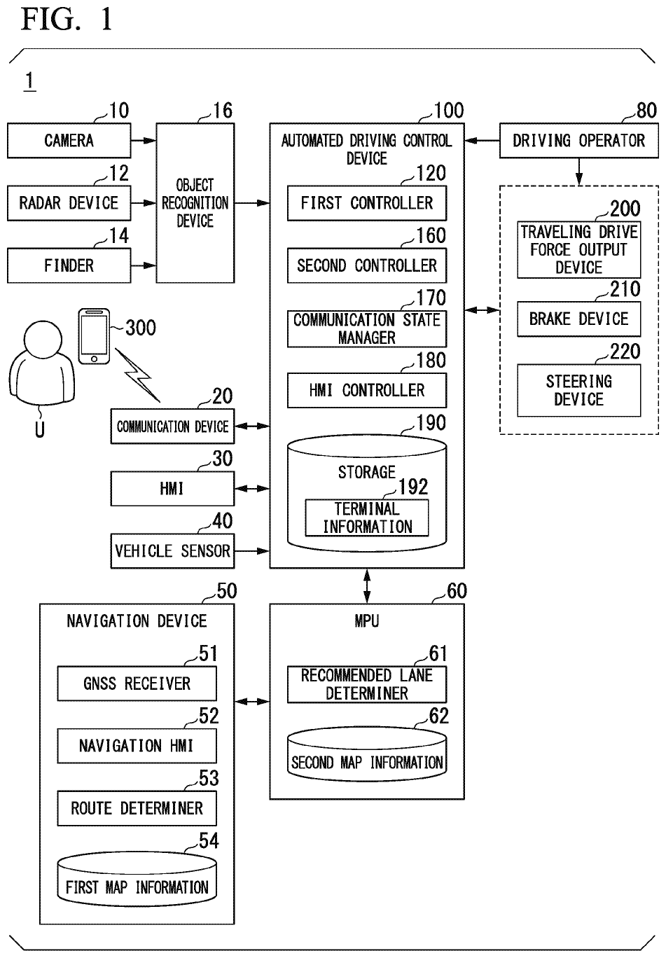

FIG. 1 is a configuration diagram of a vehicle system 1 using a vehicle control system according to an embodiment. A vehicle on which the vehicle system 1 is mounted is, for example, a two-wheel, three-wheel, or four-wheel vehicle, and a drive source thereof is an internal combustion engine such as a diesel engine or a gasoline engine, an electric motor, or a combination thereof. The electric motor operates using an electric power generated by a generator connected to the internal combustion engine or a discharge power of a battery (storage battery) such as a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices and apparatuses are connected to each other by a multiple communication line such as a controller area network (CAN) communication line, a serial communication line, a wireless communication network, or the like. The configuration shown in FIG. 1 is merely an example, and a part of the configuration may be omitted, or another configuration may also be added. A combination of the communication device 20 and the automated driving control device 100 is an example of a “driving control system.” The communication device 20 is an example of a “communicator.” The automated driving control device 100 is an example of a “driving controller.” A communication state manager 170 is an example of an “acquirer.” The HMI 30 is an example of a “notifier.” An HMI controller 180 is an example of a “notification controller.”

The camera 10 is, for example, a digital camera using a solid-state imaging sensor such as a charge coupled device (CCD) or a complementary metal oxide semiconductor (CMOS). The camera 10 is attached to an arbitrary place of a vehicle (hereinafter, a vehicle M) on which the vehicle system 1 is mounted. When the front is imaged, the camera 10 is attached to an upper part of a front windshield, a rear surface of a rear-view mirror, or the like. The camera 10 periodically and repeatedly images, for example, a periphery of the vehicle M. The camera 10 may also be a stereo camera.

The radar device 12 emits radio waves such as millimeter waves to the periphery of the vehicle M, detects at least a position (a distance and an orientation) of an object by detecting the radio waves (reflected waves) reflected by the object. The radar device 12 is attached to an arbitrary place of the vehicle M. The radar device 12 may detect the position and a speed of the object using a frequency modulated continuous wave (FM-CW) method.

The finder 14 is light detection and ranging (LIDAR). The finder 14 emits light to the periphery of the vehicle M and measures scattered light. The finder 14 detects a distance to the object on the basis of time from light emission to light reception. The emitted light is, for example, a pulsed laser beam. The finder 14 is attached to an arbitrary place of the vehicle M.

The object recognition device 16 performs sensor fusion processing on results of detection performed by some or all of the camera 10, the radar device 12, and the finder 14, and recognizes the position, type, speed, and the like of the object. The object recognition device 16 outputs a result of the recognition to the automated driving control device 100. The object recognition device 16 may output the results of detection performed by the camera 10, the radar device 12, and the finder 14 to the automated driving control device 100 as they are. The object recognition device 16 may be omitted from the vehicle system 1.

The communication device 20 uses, for example, a cellular network, a Wi-Fi network, a Bluetooth (a registered trademark), a dedicated short-range communication (DSRC), and the like, and communicates with a terminal device 300 used by an occupant U of the vehicle M, another vehicle present in the periphery of the vehicle M, a parking lot management device (to be described below), or various types of server devices. The terminal device 300 is, for example, a portable terminal such as a smartphone or a tablet terminal carried by the occupant U.

The HMI 30 presents various types of information to the occupant of the vehicle M and receives an input operation performed by the occupant. The HMI 30 includes a display device, a speaker, a buzzer, a touch panel, a switch, a key, and the like. The display device includes, for example, a meter display provided in a portion of the instrument panel, which faces the driver, a center display provided in a center of the instrument panel, a head up display (HUD), and the like. The HUD is a device that causes an image to be superimposed on a landscape and to be visually recognized, and, as an example, causes the occupant to visually recognize a virtual image by projecting light including the image to a front windshield or a combiner of the vehicle M.

The vehicle sensor 40 includes a vehicle speed sensor which detects a speed of the vehicle M, an acceleration sensor which detects acceleration, a yaw rate sensor which detects an angular speed around a vertical axis, an orientation sensor which detects a direction of the vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the vehicle M on the basis of a signal received from a GNSS satellite. The position of the vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include a curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of the terminal device 300 of the occupant U. The navigation device 50 may transmit a current position and a destination to a navigation server via the communication device 20, and acquire a route equivalent to the route on a map from the navigation server. The navigation device 50 outputs the determined route on a map to the MPU 60.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divide it every 100 [m] with respect to the vehicle traveling direction), and determines a recommended lane for each block with reference to the second map information 62. The recommended lane determiner 61 determines which numbered of lane from the left to travel. The recommended lane determiner 61 determines a recommended lane such that the vehicle M may travel a reasonable route for traveling to a branch destination when there is a branch place on the route on a map.

The second map information 62 is map information with accuracy higher than the first map information 54. The second map information 62 includes, for example, information on a center of a lane or information on a boundary of the lane. The second map information 62 may include road information, traffic regulation information, address information (addresses and postal codes), facility information, parking lot information, telephone number information, and the like. The parking lot information is, for example, a position or a shape of the parking lot, the number of parking available places, whether manned driving is possible, whether unmanned driving is possible, and the like. The second map information 62 may be updated at any time by the communication device 20 communicating with another device.

The driving operator 80 includes, for example, an accelerator pedal, a brake pedal, a shift lever, a steering wheel, a variant steer, a joystick, and other operators. A sensor that detects the amount of an operation or a presence or absence of an operation is attached to the driving operator 80. A result of the detection is output to the automated driving control device 100, or some or all of the traveling drive force output device 200, the brake device 210, and the steering device 220.

The automated driving control device 100 includes, for example, a first controller 120, a second controller 160, a communication state manager 170, an HMI controller 180, and a storage 190. Each of the first controller 120, the second controller 160, the communication state manager 170, and the HMI controller 180 is realized by a hardware processor such as a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), and may also be realized by cooperation of software and hardware. The program may be stored in a storage device (a storage device including a non-transitory storage medium) such as an HDD or a flash memory of the automated driving control device 100 in advance, and may also be stored in a detachable storage medium such as a DVD or a CD-ROM and installed in the HDD or the flash memory of the automated driving control device 100 by the storage medium (non-transitory storage medium) being attached to the drive device.

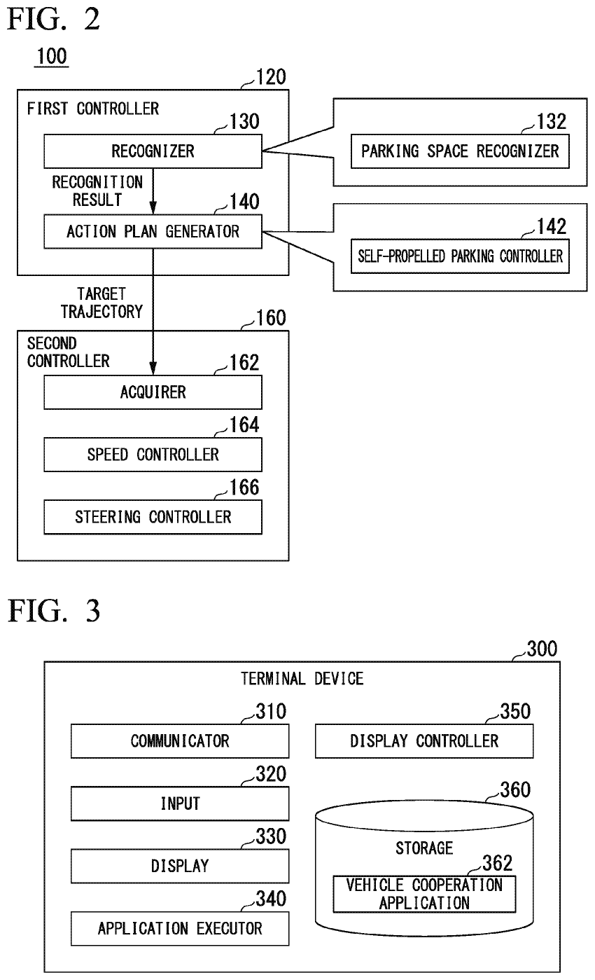

FIG. 2 is a functional configuration diagram of the first controller 120 and the second controller 160. The first controller 120 includes, for example, a recognizer 130 and an action plan generator 140. The first controller 120 realizes, for example, both a function of artificial intelligence (AI) and a function of a model given in advance. For example, a function of “recognizing an intersection” may be executed in parallel with recognition of an intersection performed by deep learning and the like and recognition based on conditions given in advance (pattern matching available signals, road marking, and the like), and may be realized by scoring and comprehensively evaluating both sides. As a result, reliability of the automated driving is ensured. The first controller 120 executes, for example, control related to the automated driving of the vehicle M on the basis of an instruction from the MPU 60, the communication state manager 170, the HMI controller 180, and the like, or an instruction from the terminal device 300.

The recognizer 130 recognizes a surrounding environment of the vehicle M on the basis of information input from the camera 10, the radar device 12, and the finder 14 via the object recognition device 16. For example, the recognizer 130 recognizes states such as the position, speed, acceleration, and the like of an object in the periphery of the vehicle M on the basis of the input information. The position of the object is, for example, recognized as the position on absolute coordinates with a representative point (a center of gravity, a center of a drive shaft, or the like) of the vehicle M as an origin, and is used for control. The position of the object may be represented by a representative point such as the center of gravity or a corner of the object, and may also be represented by an expressed area. The “states” of the object may include an acceleration, a jerk, or a “behavior state” (for example, whether the vehicle changes a lane or intends to change a lane) of the object.

The recognizer 130 recognizes, for example, a lane (traveling lane) in which the vehicle M is traveling. For example, the recognizer 130 compares a pattern of a road section line (for example, an array of solid lines and broken lines) obtained from the second map information 62 with a pattern of a road section line of the periphery of the vehicle M recognized from an image captured by the camera 10, thereby recognizing a traveling lane. The recognizer 130 may recognize the traveling lane by recognizing not only a road section line but also a traveling path boundary (a road boundary) including the road section line, a road shoulder, a curb, a median strip, a guardrail, and the like. In this recognition, the position of the vehicle M acquired from the navigation device 50 and a result of processing performed by INS may also be considered. The recognizer 130 recognizes temporary stop lines, obstacles, red lights, toll gates, entrance and exit gates of parking lots, and other road events.

The recognizer 130 recognizes the position and posture of the vehicle M with respect to the traveling lane when the traveling lane is recognized. The recognizer 130 may recognize a divergence of a reference point of the vehicle M from a center of a lane and an angle formed with respect to a line connecting lane centers in a traveling direction of the vehicle M as the relative position and posture of the vehicle M with respect to the traveling lane. Instead, the recognizer 130 may also recognize a position of the reference point of the vehicle M with respect to any side end of the traveling lane (the road section line or the road boundary) or the like as the relative position of the vehicle M with respect to the traveling lane.

The recognizer 130 includes a parking space recognizer 132 that starts in a self-propelled parking event to be described below. Details of a function of the parking space recognizer 132 will be described below.

The action plan generator 140 generates an action plan which causes the vehicle M to travel using automated driving. For example, the action plan generator 140 generates a target trajectory in which the vehicle M will automatically (without depending on an operation of the driver) travel in the future such that the vehicle M travels on a recommended lane determined by the recommended lane determiner 61 in principle, and furthermore copes with a surrounding situation of the vehicle M on the basis of a result of the recognition performed by the recognizer 130. The target trajectory includes, for example, a speed element. For example, the target trajectory is expressed as a sequential array of points (trajectory points) that the vehicle M needs to reach. The trajectory points are points that the vehicle M needs to reach for each predetermined travel distance (for example, about several [m]) on a road, and separately from this, a target speed and a target acceleration for each predetermined sampling time (for example, about 0 comma [sec]) are generated as a part of the target trajectory. The trajectory points may be positions that the vehicle M needs to reach at a corresponding sampling time for each predetermined sampling time. In this case, information on the target speed and the target acceleration is expressed by intervals between the trajectory points.

The action plan generator 140 may set an event of automated driving in generation of a target trajectory. The event of automated driving includes a constant speed event, a low speed tracking traveling event, a lane change event, a branching event, a joining event, a takeover event, a self-propelled parking event of parking with automatic traveling in a parking lot such as valet parking, and the like. The automatic traveling is, for example, traveling according to driving control of speed control and steering control of the vehicle M without depending on an operation of the occupant. The automatic traveling includes, for example, unmanned traveling. The action plan generator 140 generates a target trajectory in accordance with a started event. The action plan generator 140 includes a self-propelled parking controller 142 which starts when the self-propelled parking event is executed. Details of a function of the self-propelled parking controller 142 will be described below.

The second controller 160 controls the traveling drive force output device 200, the brake device 210, and the steering device 220 such that the vehicle M passes along the target trajectory generated by the action plan generator 140 at a scheduled time.

The second controller 160 includes, for example, an acquirer 162, a speed controller 164, and a steering controller 166. The acquirer 162 acquires information on the target trajectory (trajectory points) generated by the action plan generator 140 and causes a memory (not shown) to store it. The speed controller 164 controls the traveling drive force output device 200 or the brake device 210 on the basis of the speed element associated with the target trajectory stored in the memory. The steering controller 166 controls the steering device 220 in accordance with a bending degree of the target trajectory stored in the memory. Processing of the speed controller 164 and the steering controller 166 is realized by, for example, a combination of feedforward control and feedback control. As an example, the steering controller 166 executes the combination of feedforward control in accordance with curvature of a road ahead of the vehicle M and feedback control based on a divergence from the target trajectory.

Returning to FIG. 1, the communication state manager 170 acquires a state of communication between the communication device 20 and a terminal device. The terminal device is a device which can output an entry instruction or an exit instruction to the vehicle M when the vehicle M is caused to move into or out of a parking lot in automatic traveling according to a self-propelled parking event. The terminal device is, for example, the terminal device 300 used by the occupant U.

The communication state manager 170 acquires a state of communication with a terminal device registered in terminal information 192 stored in the storage 190. In the terminal information 192, for example, address information for communicating with the terminal device 300 is associated with a terminal ID that is information for identifying the terminal device 300. Address information of terminal devices used by each of a plurality of occupants boarding the vehicle M or a terminal device of an object which acquires a communication state at a predetermined cycle from a state in which the vehicle M has entered a parking lot may be registered in the terminal information 192. The communication state is a connection state of wireless communication between the communication device 20 and the terminal device 300.

For example, the communication state manager 170 transmits a communication state request to the terminal device 300 which is registered in the terminal information 192 at a predetermined cycle or timing, and determines that the communication state is worse than the reference when a response from the terminal device 300 to the transmitted communication state request cannot be obtained within a predetermined time, or when the received response is not normal. “The received response is not normal” means, for example, that a reception strength (for example, a received signal strength indication (RSSI)) when response data is received is equal to or less than a threshold value, that an error has occurred in error detection or error correction for the response data, that the response data is different from a predetermined data content or data format, or that other communication error has occurred. The communication state manager 170 may determine that the communication state is worse than the reference when the received response is not normal continuously for predetermined time or more. The communication state manager 170 determines that the communication state is better than the reference when the communication state is not worse than the reference (for example, a response to the communication state request is normal).

The communication state manager 170 instructs the first controller 120 to perform driving control in each control pattern to be described below when it is determined that the communication state is worse than a reference. Details of a function of the communication state manager 170 will be described below.

The HMI controller 180 notifies the occupant of predetermined information using the HMI 30. The predetermined information may include information related to a state of the vehicle M or information related to traveling of the vehicle M such as information related to driving control. The information related to the state of the vehicle M includes, for example, the speed, an engine RPM, a shift position, and the like of the vehicle M. The information related to driving control includes, for example, information on a presence or absence of execution of automated driving or a degree of driving assistance using automated driving, and the like. The predetermined information may include information not related to the traveling of the vehicle M such as content (for example, a movie) stored in a storage medium such as a DVD or a TV program. The predetermined information may include, for example, information on the communication state between the vehicle M and the terminal device 300, a current position or a destination in automatic driving, an amount of remaining fuel of the vehicle M. The HMI controller 180 may also output the information received by the HMI 30 to the communication device 20, the navigation device 50, the first controller 120, and the like.

The HMI controller 180 may communicate with the terminal device 300 stored in the terminal information 192 via the communication device 20, and transmit predetermined information to the terminal device 300. The HMI controller 180 may also cause the HMI 30 to output information acquired from the terminal device 300. For example, the HMI controller 180 may perform control to cause a display device of the HMI 30 to display a registration screen for performing registration of the terminal device 300 communicating with the vehicle M, and to cause the terminal information 192 to store information on the terminal device 300 registered via the registration screen. The registration of the terminal device 300 described above is executed at a predetermined timing before automatic traveling is started, such as when the occupant U is boarded or before the self-propelled parking event is executed. The registration of the terminal device 300 described above may be performed by an application program installed in the terminal device 300 (a vehicle cooperation application to be described below).

The HMI controller 180 may transmit information obtained by the communication state manager 170 to the terminal device 300 or other external devices via the communication device 20.

The storage 190 is realized by, for example, an HDD, a flash memory, an EEPROM, a read only memory (ROM), a random access memory (RAM), or the like. The storage 190 stores, for example, the terminal information 192 and other types of information.

The traveling drive force output device 200 outputs a traveling drive force (torque) for the traveling of a vehicle to drive wheels. The traveling drive force output device 200 includes, for example, a combination of an internal combustion engine, an electric motor, a transmission, and the like, and an electronic control unit (ECU) that controls these. The ECU controls the constituents described above according to information input from the second controller 160 or information input from the driving operator 80.

The brake device 210 includes, for example, a brake caliper, a cylinder that transmits hydraulic pressure to the brake caliper, an electric motor that generates hydraulic pressure at the cylinder, and a brake ECU. The brake ECU controls the electric motor according to the information input from the second controller 160 or the information input from the driving operator 80 so that a brake torque corresponding to a braking operation is output to each wheel. The brake device 210 may include, as a backup, a mechanism that transmits hydraulic pressure generated by an operation of a brake pedal included in the driving operator 80 to the cylinder via a master cylinder. The brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes, for example, a direction of the steering wheels by applying a force to a rack and pinion mechanism. The steering ECU drives the electric motor according to the information input from the second controller 160 or the information input from the driving operator 80, and changes the direction of the steering wheels.

[Terminal Device]

FIG. 3 is a diagram which shows an example of a functional configuration of the terminal device 300. The terminal device 300 includes, for example, a communicator 310, an input 320, a display 330, an application executor 340, a display controller 350, and a storage 360. The communicator 310, the input 320, the display 330, the application executor 340, and the display controller 350 are realized by, for example, a hardware processor such as a CPU executing a program (software). Some or all of these components may be realized by the hardware (the circuit unit; including circuitry) such as a LSI, an ASIC, a FPGA, or a GPU, and may also be realized by the cooperation of software and hardware. The program described above may be stored in a storage device (a storage device including a non-transitory storage medium) such as an HDD or a flash memory of the terminal device 300 in advance, and may also be stored in a detachable storage medium such as a DVD or a CD-ROM and installed in the storage 360 by the storage medium (non-transitory storage medium) being attached to the drive device.

The communicator 310 communicates with the vehicle M or other external devices via, for example, a network such as a local area network (LAN), a wide area network (WAN), or the Internet.

The input 320 receives an input of a user by operations of various keys, buttons, and the like. The display 330 is, for example, a liquid crystal display (LCD) or the like. The input 320 may be configured integrally with the display 330 as a touch panel.

The application executor 340 is realized by executing the vehicle cooperation application 362 stored in the storage 360. The vehicle cooperation application 362 is, for example, an application program that communicates with the vehicle M via the network and transmits response data to an entry instruction or an exit instruction in automatic traveling and a communication state request from the vehicle M to the vehicle M. The vehicle cooperation application 362 may acquire information transmitted by the vehicle M and perform control to cause the display 330 to display it. The vehicle cooperation application 362 may perform registration of the terminal device 300 or the occupant U with respect to the vehicle M, or may perform other processing related to vehicle cooperation.

The vehicle cooperation application 362 may start or end by an operation of the occupant U, and may start or end by turning on or off power of the terminal device 300. In this case, the vehicle cooperation application 362 transmits information on the start or end of the application to the vehicle M after it has started or before it ends.

The display controller 350 controls content to be displayed or timing to be displayed on the display 330. For example, the display controller 350 generates an image for displaying the information executed by the application executor 340 on the display 330, and causes the display 330 to display the generated image. The display controller 350 may generate speech associated with a part or all of the content to be displayed on the display 330, and cause the generated speech to be output from a speaker of the terminal device (not shown). The display controller 350 may display an image received from the vehicle M on the display 330, and may cause the speaker to output a speech received from the vehicle M.

The storage 360 is realized by, for example, an HDD, a flash memory, an EEPROM, a ROM, a RAM, or the like. The storage 360 stores, for example, the vehicle cooperation application 362 and other information.

[Driving Control in Automatic Traveling]

Next, driving control in the automatic traveling of the vehicle M in the embodiment will be described in detail. In the following description, description is provided using a scene in which self-propelled parking in unmanned traveling is performed for valet parking at a visiting place facility as an example of a scene in which the driving control in the automatic traveling of the vehicle M is executed.

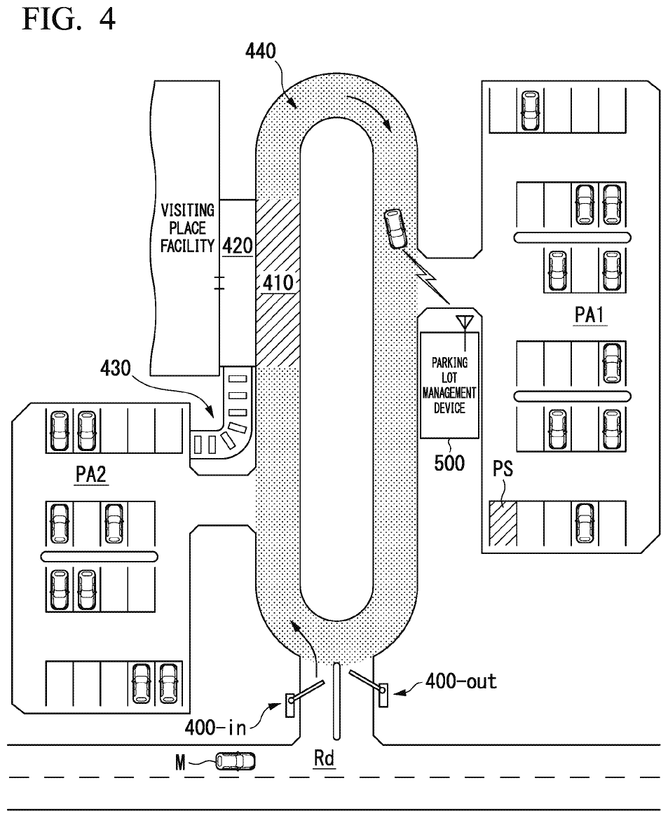

FIG. 4 is a diagram which schematically shows a scene in which the self-propelled parking event in the embodiment is executed. In the example of FIG. 4, a parking lot of a visiting place facility (for example, with valet parking) is shown. It is assumed that gates 400-in and 400-out, a stop area 410, and a boarding area 420 are provided in a route from a road Rd to the visiting place facility in the parking lot. The boarding area 420 may be divided into a boarding area and a getting-off area. It is assumed that a first parking lot (an example of a first parking area) PA1 and a second parking lot (an example of a second parking area) PA2 are provided in the parking lot. The first parking lot PA1 is an area in which only unmanned traveling vehicles can travel and people are basically not permitted to enter. The second parking lot PA2 is assumed to be, for example, an area in which unmanned traveling vehicles and manned traveling vehicles can travel and the occupants of the vehicles are permitted to pass through. An occupant who gets off a parked vehicle can move along a pedestrian crossing 430 between the second parking lot PA2 and the boarding area 420. In the example of FIG. 4, it is assumed that a parking lot management device 500 that manages parking statuses of the first parking lot PA1 and the second parking lot PA2 and transmits availability statuses, and the like to vehicles is provided.

Here, first, processing of the vehicle M at the time entering and exiting according to the self-propelled parking event will be described. The processing of the vehicle M at the time entering and exiting is executed by, for example, receiving an entry instruction and exit instruction from the terminal device 300, an elapse of time set in advance, or satisfying other execution conditions.

[Self-Propelled Parking Event-at the Time of Entry]

For example, the self-propelled parking controller 142 causes the vehicle M to park in a parking space of the first parking lot PA1 on the basis of information acquired from the parking lot management device 500 by the communication device 20. In this case, the vehicle M travels to the stop area 410 after passing through the gate 400-in according to manual driving or automated driving. The stop area 410 faces the boarding area 420 connected to the visiting place facility. The boarding area 420 is provided with eaves for averting rain and snow.

After the occupant U gets off at the stop area 410, the vehicle M performs automated driving while unmanned and starts the self-propelled parking event in which it moves to a parking space PS in the first parking area PAL A start trigger of the self-propelled parking event may be, for example, an operation performed by the occupant U (for example, an entry instruction from the terminal device 300), and may also be a wireless reception of a predetermined signal from the parking lot management device 500. When the self-propelled parking controller 142 starts the self-propelled parking event, it controls the communication device 20 such that a parking request is sent to the parking lot management device 500. Then, the vehicle M moves from the stop area 410 to the first parking lot PA1 according to guidance of the parking lot management device 500 or while sensing by itself.

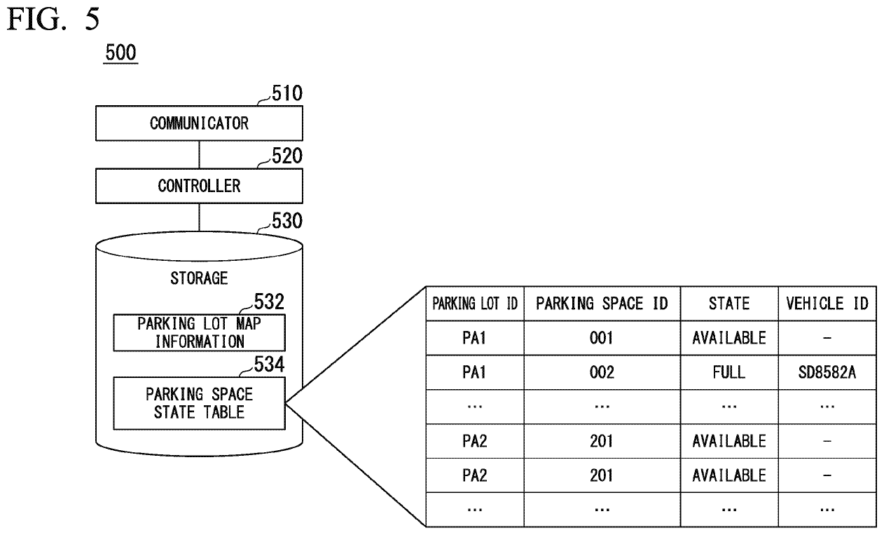

FIG. 5 is a diagram which shows an example of a configuration of a parking lot management device 500. The parking lot management device 500 includes, for example, a communicator 510, a controller 520, and a storage 530. The storage 530 stores information on parking lot map information 532, a parking space state table 534, and the like.

The communicator 510 communicates with the vehicle M and other vehicles wirelessly. The controller 520 guides the vehicles to the parking space PS on the basis of the information acquired by the communicator 510 and the information stored in the storage 530. The parking lot map information 532 is information in which structures of the first parking lot PA1 and the second parking lot PA2 are geometrically represented. The parking lot map information 532 includes coordinates for each parking space PS. In the parking space state table 534, for example, a state indicating whether a parking space is in an available state or a full (parked) state with respect to a parking lot ID that is identification information for identifying a parking lot and a parking space ID that is identification information of a parking space PS and a vehicle ID that is identification information of a vehicle which is parking in the case of the full state are associated.

If the communicator 510 receives a parking request from a vehicle, the controller 520 refers to the parking space state table 534, extracts a parking space PS that is in the first parking lot PA1 and is in the available state, acquires a position of the extracted parking space PS from the parking lot map information 532, and transmits a suitable route to the acquired position of the parking space PS to the vehicle M using the communicator 510. The controller 520 may extract, for example, a parking space which is in the available state from the second parking lot PA2 when the first parking lot PA1 is full. The controller 520 instructs an identified vehicle to stop or slow down when necessary on the basis of a positional relationship of a plurality of vehicles so that vehicles do not travel to the same position at the same time.

In the vehicle that has received the route (hereinafter, referred to as the vehicle M), the self-propelled parking controller 142 generates a target trajectory based on the route. If a target parking space PS is approached, the parking space recognizer 132 recognizes a parking frame line and the like that partition the parking space PS, recognizes a detailed position of the parking space PS, and provides it to the self-propelled parking controller 142. The self-propelled parking controller 142 corrects the target trajectory by receiving it, and allows the vehicle M to park in the parking space PS.

[Self-Propelled Parking Event-at the Time of Exit]

The self-propelled parking controller 142 and the communication device 20 remain in an operation state even while the vehicle M is parking. For example, when the communication device 20 has received a pick-up request (an example of the exit instruction) from the terminal device 300, the self-propelled parking controller 142 starts a system of the vehicle M and causes the vehicle M to move to the stop area 410. At this time, the self-propelled parking controller 142 controls the communication device 20 such that it transmits a departure request to the parking lot management device 500. The controller 520 of the parking lot management device 500 instructs an identified vehicle to stop or slow down when necessary on the basis of a positional relationship of a plurality of vehicles in the same manner as at the time of entry so that vehicles do not travel to the same position at the same time. If the vehicle M is moved to the stop area 410 and the occupant U is boarded, the self-propelled parking controller 142 stops the operation and thereafter, manual driving or automated driving by another functional unit is started.

The self-propelled parking controller 142 is not limited to the above description, and may find an available parking space by itself on the basis of a result of detection performed by the camera 10, the radar device 12, the finder 14, or the object recognition device 16 without depending on communication, and cause the vehicle M to park in a found parking space.

[Communication State Manager]

Hereinafter, details of a function of the communication state manager 170 will be described. In the following description, mainly in a state in which the vehicle M has parked in the first parking lot PA1 (for example, a state in which an entry according to the self-propelled parking event is completed), it is assumed that each control pattern of driving control based on the communication state between the communication state manager 170 and the terminal device 300 will be described.

<First Control Pattern>

In a first control pattern, the communication state manager 170 outputs a driving control instruction to cause the vehicle M to leave from the first parking lot PA1 to the first controller 120, for example, when it is determined that the communication state between the communication device 20 and the terminal device 300 is worse than the reference. The action plan generator 140 of the first controller 120 generates an action plan (a target trajectory and the like) that causes the vehicle M to leave from the first parking lot PA1 on the basis of content instructed by the communication state manager 170 and causes the second controller 160 to execute unmanned traveling on the basis of the generated action plan.

According to the first control pattern described above, it is possible to cause the vehicle M to leave from the first parking lot PA1 even if the communication state with the terminal device 300 is worse than the reference and an exit instruction from the terminal device 300 cannot be received.

<Second Control Pattern>

In a second control pattern, the communication state manager 170 generates a patrol route 440 passing through the stop area 410 after causing the vehicle M to leave from the first parking lot PA1 according to the first control pattern and outputs a driving control instruction that causes the vehicle M to patrol the generated patrol route 440 to the first controller 120. The first controller 120 makes a patrol route in a predetermined range (for example, a range that does not pass through the gate 400-out) on the basis of the surrounding environment recognized by the recognizer 130. The communication state manager 170 may generate the patrol route 440 for patrol at predetermined time intervals (for example, about 5 minutes). The first controller 120 may regenerate the patrol route in accordance with a degree of congestion in the surroundings of the patrolling vehicle. In the example of FIG. 4, an annular patrol route 440 passing through the stop area 410 is generated.

In the second control pattern, the first controller 120 causes the vehicle M to end the patrol and stop at the stop area 410 when the occupant U present at the boarding area 420 or near the boarding area 420 while patrolling the patrol route 440 is recognized by the recognizer 130. In this case, the recognizer 130 stores characteristics information of the occupant U, and the like in the storage 190 before the self-propelled parking event is executed. For example, the recognizer 130 acquires characteristics information on a face and clothes from an image of the occupant U before boarding or after getting off the vehicle, which is captured by the camera 10, and causes the storage 190 to store the acquired recognition information. The recognizer 130 may acquire the characteristics information from an image of the occupant U captured by a camera in vehicle compartment (not shown). As a result, even if there is no stop instruction and the like from the terminal device 300, it is possible to cause the patrolling vehicle M to stop at the stop area 410 and causes the occupant U to board the vehicle.

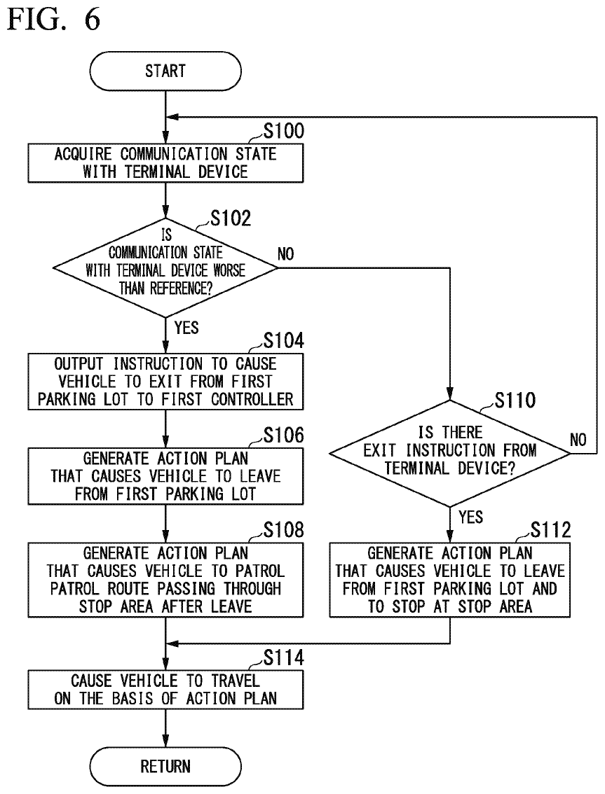

FIG. 6 is a flowchart which shows a flow of processing executed by the automated driving control device 100 in the first and second control patterns. In the following description, processing after parking of the vehicle M in the first parking lot PA1 is completed by entry processing of the self-propelled parking event will be mainly described. The same will be applied to a flow of processing in each subsequent control pattern.

First, the communication state manager 170 acquires a communication state with the terminal device of the occupant U via the communication device 20 (step S100). Next, the communication state manager 170 determines whether the communication state between the communication device 20 and the terminal device 300 is worse than a reference on the basis of the acquired communication state (step S102). When it is determined that the communication state is worse than the reference, the communication state manager 170 outputs an instruction to cause the vehicle M to exit from the first parking lot PA1 to the first controller 120 (step S104).

Next, the first controller 120 generates an action plan that causes the vehicle M to leave from the first parking lot PA1 (step S106), and generates an action plan that causes the vehicle M to patrol a patrol route that passes through a stop area after the leaving (step S108).

In the processing of step S102, when it is determined that the communication state with the terminal device 300 is better (not worse) than the reference, the communication state manager 170 determines whether there has been an exit instruction from the terminal device 300 (step S110). When it is determined that there has been an exit instruction from the terminal device, the communication state manager 170 generates an action plan to cause the vehicle M to leave from the first parking lot PA1 and to stop at the stop area 410 (step S112). After the processing of step S108 or step S112 ends, the second controller 160 causes the vehicle M to travel on the basis of the generated action plan (step S114). A combination of the processing of step S112 and step S114 corresponds to processing at the time of an exit according to the self-propelled parking event. As a result, the processing of the present flowchart ends. In the processing of step S110, when it is determined that there has been no exit instruction from the terminal device 300, the procedure returns to the processing of step S100.

According to the second control pattern described above, the same effects as in the first control pattern can be obtained, and even when the occupant U cannot perform an exit instruction to the vehicle M from the terminal device 300, it is possible to recognize the occupant present in the boarding area 420 and causes the occupant to be boarded by causing the vehicle which has left the first parking lot PA1 to patrol the patrol route 440 passing through the stop area 410. According to the second control pattern, it is possible to reduce burden of the occupant U because the occupant U does not have to move in the parking lot and search for the vehicle M. According to the second control pattern, when the occupant cannot enter the first parking lot PA1, it is possible to eliminate difficulties (a degree of difficulty) when causing the vehicle M to exit.

<Third Control Pattern>

In a third control pattern, when the vehicle M is caused to leave from the first parking lot PA1 according to the first control pattern, the communication state manager 170 determines whether a parking lot which allows unmanned traveling and manned traveling of a vehicle is present within a moveable range from the first parking lot PA1. Then, when a parking lot that allows unmanned traveling and manned traveling of a vehicle is present, the communication state manager 170 causes the vehicle M to leave from the first parking lot PA1 and outputs a driving control instruction to cause the vehicle to park in the parking lot to the first controller 120. The movable range is, for example, an area of a parking lot associated with a visiting place facility, and is an area in which the vehicle can travel. The movable range may be a range within a predetermined distance from the stop area 410 or a range in which the gate 400-out is not passed through.

In the example of FIG. 4, the second parking lot PA2 which allows unmanned traveling and manned traveling is present within the movable range from the first parking lot PAL For this reason, when the communication state with the terminal device 300 is worse than the reference, the communication state manager 170 causes the vehicle M to leave from the first parking lot PA1 and to park in the second parking lot PA2. An inquiry about a parking space in the second parking lot PA2 may be made to the parking lot management device 500, and the parking space may be determined by acquiring an available state of the second parking lot PA2 or the parking space may be determined on the basis of a surrounding situation recognized by the recognizer 130 after the vehicle has moved to the second parking lot PA2. The determination of the parking space is executed by, for example, the communication state manager 170.

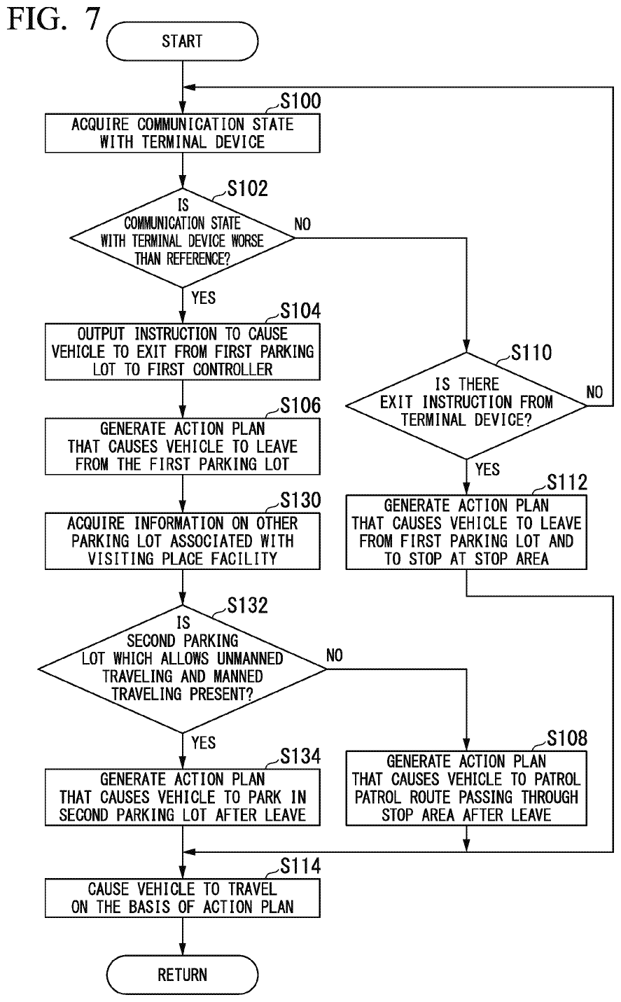

FIG. 7 is a flowchart which shows a flow of processing executed by the automated driving control device 100 in the third control pattern. The flowchart shown in FIG. 7 is different from the processing in the flowchart shown in FIG. 6 in that processing of steps S130 to S134 is added. Therefore, in the following description, the processing of steps S130 to S134 will be mainly described and description of other processing will be omitted.

In the processing of step S106, after an action plan that causes the vehicle M to leave from the first parking lot PA1 is generated (step S106), the communication state manager 170 refers to the second map information 62 and acquires information on other parking lots associated with the visiting place facility (information on parking lots other than the first parking lot PA1) (step S130). Next, the communication state manager 170 determines whether a second parking lot PA2 which allows unmanned traveling and manned traveling is present among the acquired information on parking lots (step S132). The processing of step S130 and step S132 may be performed by the first controller 120 which has received a driving control instruction from the communication state manager 170.

When it is determined that the second parking lot PA2 is present, the first controller 120 generates an action plan that causes the vehicle M to leave from the first parking lot PA1 and to park in the second parking lot PA2 (step S134). When it is determined that the second parking lot PA2 is not present, the first controller 120 generates an action plan that causes the vehicle M to patrol a patrol route passing through a stop area after the leaving (step S108).

After the processing of step S134, step S108, or step S112 ends, the second controller 160 causes the vehicle M to travel on the basis of the generated action plan (step S114). As a result, the processing of the present flowchart ends.

According to the third control pattern, the same effects as in the first and second control patterns can be obtained, and, for example, even when the communication state between the terminal device 300 and the vehicle M is worse than the reference, it is possible to search for and find the vehicle M in the second parking lot PA2 by causing the vehicle M to park in the second parking lot PA2 which the occupant U can enter. According to the third control pattern, when the second parking lot PA2 is present, even if it takes a long time to return to the boarding area 420 after the occupant U gets off the vehicle, since no patrolling and the like are performed, it is possible to alleviate traffic congestion and the like in a patrol route and to reduce a cost incurred by patrol traveling.

<Fourth Control Pattern>

In a fourth control pattern, when it is estimated that the communication state with the terminal device 300 has become worse than the reference due to power of the terminal device 300 being intentionally turned off by the occupant U, the communication state manager 170 does not execute leaving from the first parking lot PA1. For example, when a signal indicating that the power has been turned off is received from the terminal device 300, the communication state manager 170 may estimate that the communication state with the terminal device 300 has been worse than the reference due to the power being intentionally turned off by the occupant U. When a state in which communication with the terminal device 300 is not possible has continued for a predetermined time or more, the communication state manager 170 may estimate that the communication state with the terminal device 300 has become worse than the reference due to the power being intentionally turned off by the occupant U. The “state in which communication with the terminal device 300 is not possible” is, for example, a state in which no response data has been received after a communication state request is transmitted from the communication device 20.

The communication state manager 170 may estimate that the power has been intentionally turned off when the visiting place facility is a predetermined facility. The predetermined facility is, for example, an airport, a hospital, a movie theater, or any other facility in which turning off of power is recommended or obligated. The communication state manager 170 refers to the second map information 62 on the basis of the positional information of the vehicle M or positional information of the terminal device 300 acquired from the terminal device 300, and acquires facility information of a visiting place facility associated with the positional information. Then, the communication state manager 170 estimates that the power of the terminal device 300 is intentionally turned off by the occupant U when the facility information corresponds to a predetermined facility.

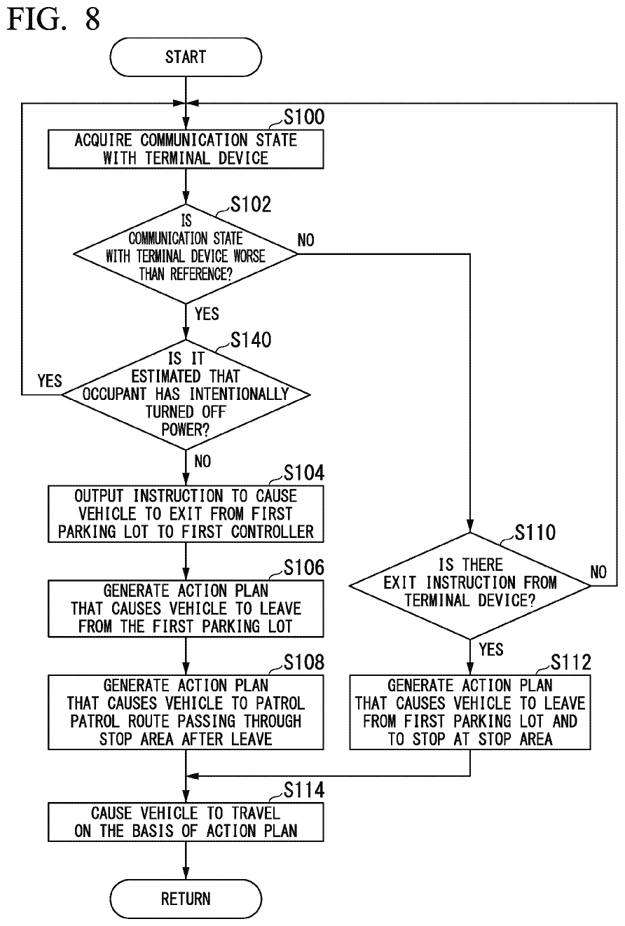

FIG. 8 is a flowchart which shows a flow of processing executed by the automated driving control device 100 in the fourth control pattern. The flowchart shown in FIG. 8 is different from the processing in the flowchart shown in FIG. 6 in that processing of step S140 is added between the processing of step S102 and the processing of step S104. Therefore, in the following description, the processing of step S140 will be mainly described and description of other processing will be omitted.

In the processing of step S102, when it is determined that the communication state between the communication device 20 and the terminal device 300 is poor, the communication state manager 170 determines whether the occupant U is estimated to intentionally turn off the power of the terminal device 300 (step S140). When it is estimated that the occupant has intentionally turned off the power, the parking state in the first parking lot PA1 is continued, and the procedure returns to the processing of step S100. When it is not estimated that the occupant U has intentionally turned off the power, the communication state manager 170 executes the processing of step S104 and thereafter.

According to the fourth control pattern described above, the same effects as in the first and second control patterns can be obtained, and, for example, when it is determined that the occupant has intentionally turned off the power of the terminal device 300, since it is predicted that terminal device 300 will be turned on and the communication state will be improved, it is possible to inhibit inappropriate vehicle control by causing the parking state in the first parking lot PA1 to continue. According to the fourth control pattern, it is possible to improve estimation accuracy by estimating whether the occupant U has intentionally turned off the power of the terminal device 300 on the basis of whether the visiting place facility of the occupant U is a predetermined facility.

<Fifth Control Pattern>

In a fifth control pattern, the communication state manager 170 does not execute the leaving from the first parking lot PA1 when the terminal device 300 is present in a visiting place facility associated with the first parking lot PA1, and executes the leaving from the first parking lot PA1 when the terminal device 300 is present outside the visiting place facility. As a result, it is possible to perform exit processing at an appropriate timing and to reduce waiting time of the occupant U in the boarding area 420.

In the fifth control pattern, the communication state manager 170 may not allow the vehicle M to leave from the first parking lot PA1 when a plurality of terminal devices 300 are registered in the terminal information 192 and the communication state with at least one terminal device 300 among the plurality of registered terminal devices is better than the reference. In this case, the communication state manager 170 does not perform the leaving from the first parking lot PA1, for example, when there is at least one terminal device which is present within the visiting place facility and has a communication state better than the reference among all the terminal devices registered in the terminal information 192.

The communication state manager 170 may set priorities for the plurality of terminal devices registered in the terminal information 192 and acquire communication states in order of the set priorities when the communication states with the plurality of terminal devices are acquired. In this case, when there is a terminal device which has the communication state better than the reference, the communication state manager 170 does not acquire the communication states with subsequent terminal devices. The priority is automatically set in order of, for example, the terminal device of a driver, the terminal device of an occupant capable of driving other than the driver, and the terminal device of an occupant not capable of driving. The priority may be arbitrarily set by the occupant U from the HMI 30 or the terminal device 300. As compared to a case in which the communication states with all the registered terminal devices are acquired, it is possible to reduce acquisition processing of the communication states by acquiring the communication state in order of the priority. When the communication state of a terminal device determined to have the good communication state has become worse than the reference, the communication state manager 170 may acquire a re-connection state in the order of the priority.

For example, when there is at least one terminal device which is present outside the visiting place facility and has the communication state better than the reference among all the terminal devices registered in the terminal information 192, the communication state manager 170 may output a driving control instruction to perform the leaving from the first parking lot PA1 and causes the vehicle to stop at the stop area 410 to the first controller 120. As a result, even if an exit instruction has not been received, it is possible to perform exit processing at an appropriate timing.

For example, when the communication states with all the terminal devices registered in the terminal information 192 are better than the reference and all the terminal devices are present in a predetermined area (for example, the boarding area 420) outside the visiting place facility, the communication state manager 170 may output a driving control instruction to cause the vehicle M to leave from the first parking lot PA1 and to stop at the stop area 410 to the first controller 120. As a result, it is possible to cause all occupants to be boarded smoothly with a shortened vehicle-stopping time for performing a pick-up in a state in which everyone is in line.

When communication states of all terminal devices registered in the terminal information 192 are worse than the reference, the communication state manager 170 may output a driving control instruction to cause the vehicle M to exit from the first parking lot PA1 to the first controller 120.

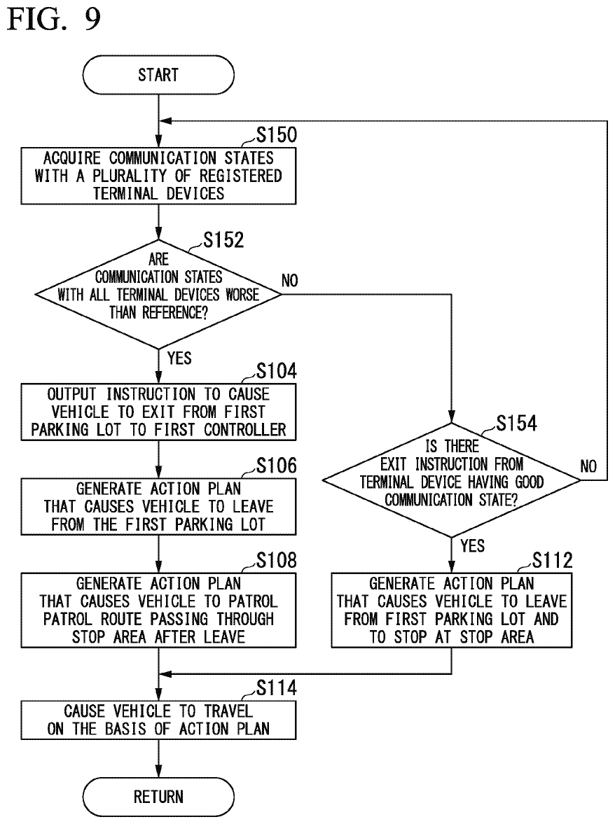

FIG. 9 is a flowchart which shows a flow of processing executed by the automated driving control device 100 in the fifth control pattern. The flowchart shown in FIG. 9 is different from the processing in the flowchart shown in FIG. 6 in that processing of step S150, step S152, and step S154 is included instead of the processing of step S100, step S102, and step S110. Therefore, in the following description, the processing of step S150, step S152, and step S154 will be mainly described and description of other processing will be omitted.

First, the communication state manager 170 acquires communication states with a plurality of registered terminal devices (step S150). Next, the communication state manager 170 determines whether the acquired communication states with all terminal devices are worse than the reference (step S152). When it is determined that the acquired communication states with all terminal devices are worse than the reference, the communication state manager 170 executes processing of step S104 and thereafter. When it is determined that the communication states with all terminal devices are not worse than the reference (in order words, the communication state with at least one terminal device is better than the reference), the communication state manager 170 determines whether there is an exit instruction from the terminal device 300 which has a good communication state (step S154). When it is determined that there is an exit instruction from the terminal device 300 which has a good communication state, the processing of S112 and thereafter is performed. When it is determined that there is no exit instruction from the terminal device which has a good communication state, the procedure returns to the processing of step S150.

According to the fifth control pattern described above, the same effects as in the first and second control patterns can be obtained, and, for example, even when the communication state with the terminal device 300 of the driver is deteriorated, when a plurality of terminal devices 300 are registered (paired) in the vehicle M, it is possible to receive an exit instruction from the terminal device 300 and execute driving control. As a result, for example, when the communication state with a terminal device used by an occupant (for example, an occupant seated in a passenger seat) other than the driver is good, it is possible to perform an exit instruction on the vehicle M using the terminal device.

<Sixth Control Pattern>

In a sixth control pattern, the communication state manager 170 may cause the HMI controller 180 to notify the administrator of the first parking area PA1 that an exit based on automated driving is not possible when it is determined that the communication state between the communication device 20 and the terminal device 300 is worse than the reference. Specifically, for example, the communication state manager 170 causes the HMI controller 180 to generate information on a current position (a parking position) of the vehicle M and a reason why an exit is not possible (for example, the communication state with the terminal device 300 is poor), and causes the generated information to be transmitted to the parking lot management device 500 from the communication device 20.

As a result, an administrator of the parking lot management device 500 can accurately ascertain the position of the vehicle M and the reason why an exit is not possible, and appropriately respond to inquiries from the occupant U. In this case, for example, the administrator of the parking lot management device 500 performs responses such as temporarily stopping the entry and exit of a vehicle into or from the first parking lot PA1, permitting the occupant U to enter the first parking lot PA1, and causing the occupant U to drive the vehicle M and leave from the first parking lot PAL Instead of the examples described above, responses of permitting an identified person such as the administrator to enter the first parking lot PA1 and causing the person to drive the vehicle M and leave from the first parking lot PA1 may also be performed.

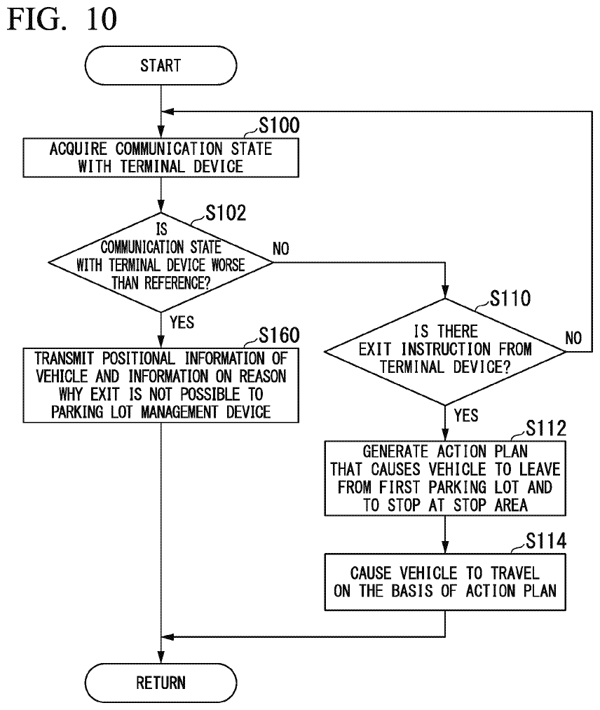

FIG. 10 is a flowchart which shows a flow of processing executed by the automated driving control device 100 in the sixth control pattern. The flowchart shown in FIG. 10 is different from the processing in the flowchart shown in FIG. 6 in that processing of step S160 is included instead of the processing of steps S104 to S108. Therefore, in the following description, the processing of step S160 will be mainly described and description of other processing will be omitted.

In the processing of step S102, when it is determined that the communication state with the terminal device is worse than the reference, the communication state manager 170 generates the positional information of the vehicle M and information on a reason why the vehicle cannot exit using the HMI controller 180, causes the generated information to be transmitted to the parking lot management device 500 (step S160) and ends the processing of the present flowchart. In the example of FIG. 10, after the processing of step S112 ends, the second controller 160 causes the vehicle to travel on the basis of an action plan (step S114).

According to the sixth control pattern described above, it is possible to prevent the position and state of the vehicle M parked in the first parking lot PA1 from being unable to be ascertained by notification to the administrator of the first parking lot PA1.

<Seventh Control Pattern>

In a seventh control pattern, for example, when it is determined that the communication state between the communication device 20 and the terminal device 300 is worse than the reference and the reservation time for arrival (reservation time for an exit) of the occupant U is set in advance, the communication state manager 170 outputs a driving control instruction to cause the vehicle M to leave the first parking lot PA1 at a timing when the reservation time for arrival is reached or a time that is a predetermined time (for example, 3 to 5 minutes) before the reservation time for arrival is reached to the first controller 120.

In this case, the HMI controller 180 makes an inquiry about the reservation time for arrival before an entry instruction is received from the occupant U, and stores an input result of the occupant for the inquiry in the storage 190. The reservation time for arrival may be, for example, a date and time (for example, 15:30 on December 24), or may be an elapsed time (for example, 2 hours later) after entry processing based on unmanned traveling is started.

Then, when it is determined that the communication state between the communication device 20 and the terminal device 300 is worse than the reference, the communication state manager 170 refers to the reservation time for arrival stored in the storage 190 and executes processing at the time of exit of the self-propelled parking event at a timing at which a current time reaches the reservation time for arrival or has reached a time that is a predetermined time before the reservation time for arrival.

The communication state manager 170 may generate the patrol route 440 in the same manner as in the second control pattern after exit processing of the vehicle M has been performed on the basis of the reservation time for arrival, and cause the first controller 120 to execute control to cause the vehicle to patrol the generated patrol route 440.

The communication state manager 170 may perform control to return to the first parking lot PA1 when the occupant U is not boarded even after a predetermined time has elapsed from the reservation time for arrival described above. The communication state manager 170 may cause the vehicle M to park in the second parking lot PA2 when the vehicle returns to the first parking lot PA1 and there is no parking space.

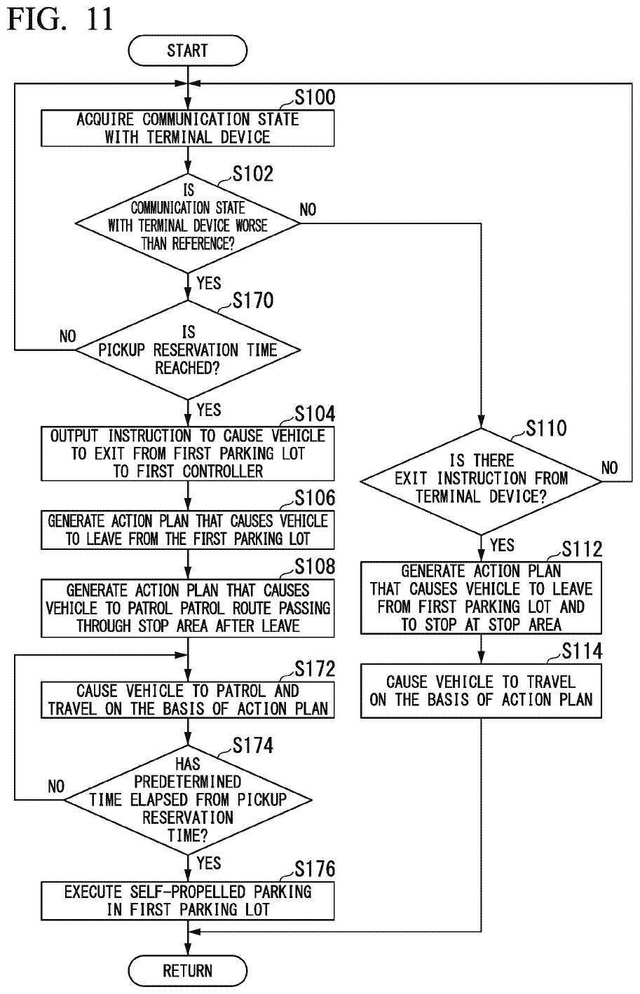

FIG. 11 is a flowchart which shows a flow of processing executed by the automated driving control device 100 in the seventh control pattern. The flowchart shown in FIG. 11 is different from the processing in the flowchart shown in FIG. 6 in that processing of step S170 is added between the processing of step S102 and the processing of step S104, and processing of steps S172 to S176 is added after the processing of step S108. Therefore, in the following description, the processing of steps S170 to S176 will be mainly described and description of other processing will be omitted. In the example of FIG. 11, it is assumed that a reservation time for arrival is set in advance.

In the processing of step S102, when it is determined that the communication state with the terminal device is worse than the reference, the communication state manager 170 determines whether a pickup reservation time set in advance is reached (step S170). When it is determined that the pickup reservation time set in advance is not reached, the communication state manager 170 returns to the processing of step S100 while a parking state in the first parking lot PA1 continues. In addition, when it is determined that the pickup reservation time set in advance is reached, the communication state manager 170 executes the processing of steps S104 to S108.

After the processing of step S108, the second controller 160 causes the vehicle M to patrol along the patrol route 440 passing through the stop area 410 on the basis of an action plan (step S172). Next, the first controller 120 determines whether a predetermined time has elapsed from the pickup reservation time (step S174). When it is determined that the predetermined time has not elapsed from the pickup reservation time, the procedure returns to the processing of step S172. When the predetermined time has elapsed from the pickup reservation time, the first controller 120 generates an action plan that returns the vehicle M to the first parking lot PA1, and causes the second controller 160 to execute self-propelled parking on the basis of the generated action plan (step S176). In the example of FIG. 11, the second controller 160 causes the vehicle to travel on the basis of the action plan after the processing of step S112 ends (step S114).

According to the seventh control pattern described above, the same effects as in the first and second control patterns can be obtained, for example, and it is possible to perform exit processing at an appropriate timing by causing the vehicle M to exit at the reservation time for arrival even when an exit instruction from the terminal device 300 is not received. Furthermore, according to the seventh control pattern, when a predetermined time has elapsed from the reservation time for arrival, since extra patrol traveling can be suppressed by causing the vehicle to park in the second parking lot PA2, it is possible to suppress occurrence of traffic congestion in the patrol route 440 and to execute more appropriate driving control.

Each of the first to seventh control patterns described above may be a combination of some or all of other control patterns.

In the embodiments described above, it has been described that it is assumed that the first parking lot PA1 is an area in which only unmanned traveling vehicles can travel, and the second parking lot PA2 is an area in which unmanned traveling and manned traveling vehicles can travel, but the present invention is not limited thereto. For example, it may also be assumed that the first parking lot PA1 is an area in which parking according to traveling with driving control based on the speed control and steering control of the vehicle M is possible without depending on the operation of the occupant, and the second parking lot PA2 is an area in which parking according to traveling based on the manual driving of the occupant is possible. In this case, the first parking lot PA1 includes, for example, an area in which a person is prohibited from entering a part or all of the parking lot and an area in which there is a risk of a person entering (for example, an area in which the person entering is highly likely to interfere with a movement of other vehicles in the parking lot).

[Hardware Configuration]

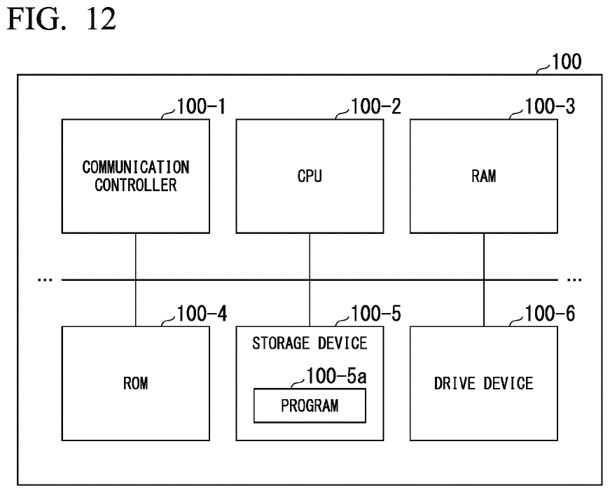

FIG. 12 is a diagram which shows an example of a hardware configuration of the automated driving control device 100 of the embodiment. As shown in FIG. 12, a computer of the automated driving control device 100 is configured by a communication controller 100-1, a CPU 100-2, a RAM 100-3 that is used as a working memory, a ROM 100-4 that stores a booting program and the like, a storage device 100-5 such as a flash memory or an HDD, a drive device 100-6, and the like being connected to one another using an internal bus or a dedicated communication line. The communication controller 100-1 communicates with components other than the automated driving control device 100. The storage device 100-5 stores a program 100-5a that is executed by the CPU 100-2. This program is expanded in the RAM 100-3 by a direct memory access (DMA) controller (not shown) and the like, and is executed by the CPU 100-2. As a result, some or all of the components of the automated driving control device 100 are realized.

The embodiments described above can be expressed as follows.

A vehicle control system is configured to include a storage device that has stored a program and a hardware processor, recognize a surrounding environment of a vehicle, perform driving control of speed control and steering control of the vehicle without depending on an operation of an occupant on the basis of a recognized result, communicate with a terminal device, acquire a communication state with the terminal device, and cause a vehicle to leave from a first parking area when the vehicle is parked in the first parking area in which the vehicle parks according to traveling based on the driving control and the acquired communication state with the terminal device is worse than a reference by the hardware processor executing the program stored in the storage device.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a recognizer configured to recognize a surrounding environment of a vehicle;
a driving controller configured to perform driving control of speed control and steering control of the vehicle without depending on an operation of an occupant on the basis of a result of the recognition performed by the recognizer;
a communicator configured to communicate with a terminal device of the occupant; and
an acquirer configured to acquire a communication state between the communicator and the terminal device,
wherein the driving controller causes a vehicle to leave from a first parking area when the vehicle is parked in the first parking area in which the vehicle parks according to traveling based on the driving control and the communication state with the terminal device acquired by the acquirer is worse than a reference.

2. The vehicle control system according to claim 1,
wherein the driving controller causes the vehicle which has left from the first parking area to patrol a patrol route passing through a stop area in which the occupant is boarded.

3. The vehicle control system according to claim 1,
wherein, when a second parking area which allows traveling based on the driving control and traveling based on manual driving of an occupant of the vehicle is present within a movable range from the first parking area, the driving controller causes the vehicle which has left from the first parking area to park in the second parking area.

4. The vehicle control system according to claim 1,
wherein the driving controller does not execute leaving of the vehicle from the first parking area when it is estimated that the communication state with the terminal device is worse than the reference due to power of the terminal device being intentionally turned off by the occupant of the vehicle.

5. The vehicle control system according to claim 1,
wherein the driving controller determines whether to cause the vehicle to leave from the first parking area when the communication state with the terminal device acquired by the acquirer is worse than the reference on the basis of facility information associated with the first parking area recognized by the recognizer.

6. The vehicle control system according to claim 1,
wherein the driving controller does not execute the leaving from the first parking area when the terminal device is present in a facility associated with the first parking area, and executes the leaving from the first parking area when the terminal device is present outside the facility.

7. The vehicle control system according to claim 6,
wherein the communicator communicates with a plurality of the terminal devices registered in advance, and
the driving controller does not execute the leaving of the vehicle from the first parking area when at least one terminal device whose communication state with the communicator is better than the reference is present within the facility among the plurality of terminal devices, and executes the leaving from the first parking area when the at least one terminal device is present outside the facility.

8. The vehicle control system according to claim 1, further comprising:
a notification controller configured to perform notification on an administrator of the first parking area when the vehicle is parked in the first parking area and the communication state with the terminal device is worse than the reference.

9. The vehicle control system according to claim 1,
wherein, when a reservation time for arrival at which an occupant is boarded on the vehicle is set, the driving controller causes the vehicle to leave from the first parking area and to move to a boarding area of the occupant on the basis of the reservation time for arrival.

10. The vehicle control system according to claim 9,
wherein the driving controller causes the vehicle to leave from the first parking area before the reservation time for arrival is reached, and causes the vehicle to park in the first parking area when the occupant is not boarded even after a predetermined time has elapsed from the reservation time for arrival.

11. A vehicle control method comprising:
by computer,
recognizing a surrounding environment of a vehicle;
performing driving control of speed control and steering control of the vehicle without depending on an operation of an occupant on the basis of a recognized result;
communicating with a terminal device of the occupant;
acquiring a communication state with the terminal device; and
causing a vehicle to leave from a first parking area when the vehicle is parked in the first parking area in which the vehicle parks according to traveling based on the driving control and the acquired communication state with the terminal device is worse than a reference.

12. A computer readable non-transitory storage medium which has stored a program that causes a computer to
recognize a surrounding environment of a vehicle;
perform driving control of speed control and steering control of the vehicle without depending on an operation of an occupant on the basis of a recognized result;
communicate with a terminal device of the occupant;
acquire a communication state with the terminal device; and
cause a vehicle to leave from a first parking area when the vehicle is parked in the first parking area in which the vehicle parks according to traveling based on the driving control and the acquired communication state with the terminal device is worse than a reference.
